(19) United States
(12) Patent Application Publication
(10) Pub. No.: US 2020/0363051 A1
(43) Pub. Date: Nov. 19, 2020

(54) Emergency Lighting Device with Thermally Separated Lighting Module and Emergency Module

(71) Applicant: Mester LED Limited, Shenzhen (CN)

(72) Inventors: Erhua Ma, Shenzhen (CN); Chunjiang Shuai, Guangzhou (CN); Chunhai Wang, Nanping (CN)

(21) Appl. No.: 16/587,077

(22) Filed: Sep. 30, 2019

(30) Foreign Application Priority Data
May 16, 2019 (CN) 201910402297.7

(51) Int. Cl. F21V 29/10; F21S 9/02; F21V 29/77

(52) U.S. Cl. CPC F21V 29/10; F21V 21/08; F21V 29/773; F21S 9/022

(57) ABSTRACT

The device includes a lighting module with a light source, a light source driver, and a cooling element; an emergency module with a housing, an emergency control and a battery pack; and a connector having a cavity, a first one end is connected to the lighting module, and a second end connected to the emergency module. The cavity of the connector forms a closed space which thermally separates the emergency module from the lighting module.

### CROSS REFERENCE TO RELATED APPLICATIONS

The present application claims the benefit of Chinese Patent Application No. 201910402297.7 filed on May 16, 2019, the contents of which are incorporated herein by reference in their entirety.

### FIELD OF THE INVENTION

The invention relates to the technical field of lighting, in particular to an emergency lighting device and a method for reducing temperature thereof.

### BACKGROUND OF THE INVENTION

As a common lighting device, high bay light, also commonly known as LED bay light, is often used in the production and operation areas of factories, mines, warehouses and high bays. Since this type of light is installed in a complex environment in need of large lighting range and high power consumption thereof, once power failure takes place, production interruption or even accidents might happen resultantly. For this reason, it is usually necessary to make the lighting device into an emergency lighting device. However, the emergency high bay light generally consists of a power supply, a radiator, a light source, an emergency control and so on. Generally, the emergency control is horizontally fixed to the side of the light body. As most of these emergency lights are suspended by hooks, it is difficult to install them correctly due to their center-of-gravity offset. Alternatively, the emergency control and the power supply are installed in a mounting cavity. However, the mounting cavity and the light source are connected to the ends of the radiator respectively; for convenience of installation, the light source is located under the radiator and the heat generated by the light source gives out through the radiator. The power source and the emergency control are arranged in the mounting cavity above the radiator, so they are heated by the radiator just like a pan on an oven. Although the LED power supply driver can work at a high temperature of 90° C. and remain unaffected by LED heating, the operating ambient temperature of the emergency control is below 50° C. and the tolerable temperature of thereof is below 70° C. Obviously, the emergency control is located in an environment where the temperature is higher than its normal operating temperature, thus threatening the emergency control, causing serious potential safety hazards and reducing its service life.

As shown in FIG. 1, the invention (patent No. CN206036741U) discloses an emergency high bay light of the prior art, comprising a mounting housing 1, a heating panel 6, a mounting cavity 11, a mounting box 5 matched with the mounting cavity 11, an emergency driver 3 and a storage battery 4 which are arranged in the mounting box 5, and a light 2 positioned on the other side of the mounting housing 1. The mounting box 5 is arranged in the mounting cavity 11, and the heating panel is located under and around the mounting box 5. The heat generated by the light body passes through a radiator and brings heating effect on the mounting box, which affects the ambient temperature of the emergency driver and the storage battery in the mounting box 5, causing serious potential safety hazards.

Therefore, it is necessary to provide an emergency lighting device capable of maintaining the ambient temperature of the emergency control and allowing such control to work at normal ambient temperature.

### SUMMARY OF THE INVENTION

The main purpose of the invention is to provide an emergency lighting device capable of reducing the ambient temperature of an emergency control for the light, reducing hidden dangers and improving the service life.

Another purpose of the invention is to provide a method for reducing temperature thereof.

In order to achieve the purposes, on one hand, the invention provides an emergency lighting device, comprising a lighting module, an emergency module and a connector; the connector has a cavity, and one end thereof is connected with the lighting module and the other end is connected with the emergency module; the cavity of the connector forms a closed space after being connected with the lighting module and the emergency module; the closed space separates the emergency module from the lighting module.

Further, the emergency lighting device comprises a sealing plug which is arranged between the connector and the lighting module, and/or between the connector and the emergency module.

Further, the lighting module comprises a light-emitting element, a light source driver and a cooling element; the upper and lower parts of the cooling element have respective cavities; the light source driver is arranged in the upper cavity and the light-emitting element is arranged in the lower cavity.

Further, the cooling element is provided with a first interface to which the connector is connected.

Further, the emergency lighting device comprises a first sealing plug which is arranged between the connector and the first interface.

Further, the emergency module comprises a housing, an emergency control and a battery pack; the emergency control and the battery pack are arranged in the housing.

Further, one side of the housing is provided with a fixed structure, the other side is provided with a second interface, and the connector is connected to the second interface.

Further, the emergency lighting device comprises a second sealing plug which is arranged between the connector and the second interface.

Further, the emergency control and the battery pack are evenly counterweighted, and the gravity centerline of the lighting device passes through the connector.

On the other hand, the invention further provides a method for reducing temperature thereof, comprising the following steps of:

i, Dividing the emergency lighting device into a high-temperature area, a low-temperature working area and a partition area;

ii, Connecting the low-temperature working area and the high-temperature area with the partition area respectively to allow the partition area to form a closed space;

iii, Separating the low-temperature working area from the high-temperature area by the closed space to cut off the heat convection between the high-temperature area and the low-temperature working area.

The steps of the method for reducing temperature of the emergency lighting device correspond to those for the emergency lighting device aforementioned as follows:

Step I corresponds to the step of dividing the emergency lighting module into an emergency module, a lighting module and a connector;

Step II corresponds to the step of connecting the emergency module and the lighting module with the connector respectively to allow the connector to form a closed space;

Step III corresponds to the step of separating the low-temperature working area from the high-temperature area by the closed space to cut off the heat convection between the high-temperature area and the low-temperature working area.

To sum up, a connector is creatively introduced to the emergency lighting device of the invention to separate the lighting module from the emergency module, so the two modules can form a heat transfer partition to cut off the heat convection between the lighting module and the emergency module, and reduce the effect of heat generated by the light source on the electronic devices, thus improving the safety and service life of the lighting device.

### BRIEF DESCRIPTION OF THE DRAWINGS

The drawings of description forming a part of the application are used for further understanding of the invention. The exemplary embodiments of the invention and description thereof are used to explain the invention, but not improperly limit thereto. In the drawings:

FIG. 1 is an exploded view of an emergency lighting device in the prior art;

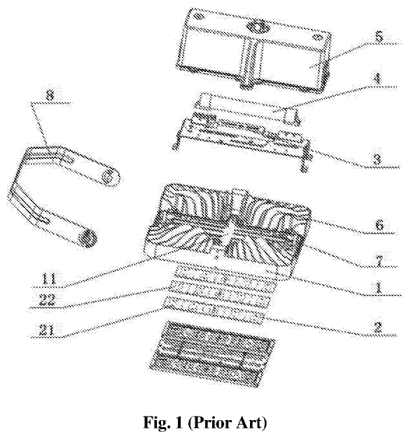

FIG. 2 is a structural exploded view of an emergency lighting device in an embodiment;

FIG. 3 is a structural section view of an emergency lighting device in an embodiment;

FIG. 4 is a logic block diagram showing a method for reducing temperature of an emergency lighting device in an embodiment;

Wherein, the above drawings include the following marks:

housing 1, heating panel 6, mounting cavity 11, mounting box 5, emergency driver 3, battery 4, light 2, wire pin 7, handle 8, illuminator 21, emergency light 22;

emergency lighting device 10, emergency module 100, connector 200, lighting module 300, housing 101, first interface 102, fixed structure 103, emergency control 104, battery pack 105, first sealing plug 201, second sealing plug 202, light-emitting element 301, second interface 302, cooling element 303, and light source driver 304.

### DETAILED DESCRIPTION OF THE PREFERRED EMBODIMENT

It should be noted that the following detailed description is exemplary and is intended to provide further explanation to this application. Unless otherwise specified, all technical and scientific terms used herein have the same meanings as commonly understood by those of ordinary skill in the art. It should be noted that the terms used herein are for the purpose of describing the embodiments only, and are not intended to limit the exemplary embodiments according to the application. For example, the “seal” included in the elements herein does not mean that a single element forms a seal or gets sealing result, but rather means that the ultimate purpose of the element in the entire device is to form a seal or makes a contribution in the sealing process. The singular forms used are intended to include the plural forms as well, unless the context clearly dictates otherwise. It should also be understood that the terms “including” and/or “comprising” used in this specification indicate the presence of features, steps, operations, devices, components, and/or combinations thereof. The embodiments and the features in the embodiments of the application can be combined with each other without conflict. Aforementioned and other technical contents, features and effects related to the invention will become apparent from the following detailed description of the preferred embodiment used in combination with the drawings. The directional terms mentioned in the following embodiments, such as upper, lower, left, right, front or rear, are only the directions indicated on the drawings. Accordingly, the directional terms are used but to illustrate not intended to limit the invention.

For an emergency lighting device of the invention, a connector is directly arranged between the emergency module and the lighting module to separate them spatially, so that the heat transfer therebetween is prevented to achieve the effect of reducing the ambient temperature for the emergency module, improving the reliability of the emergency lighting device and prolonging the service life.

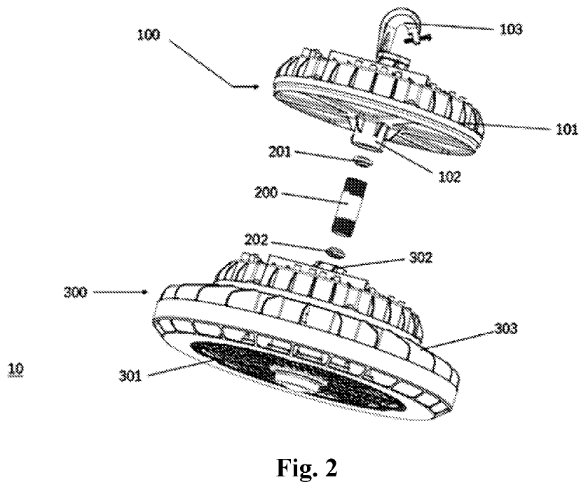

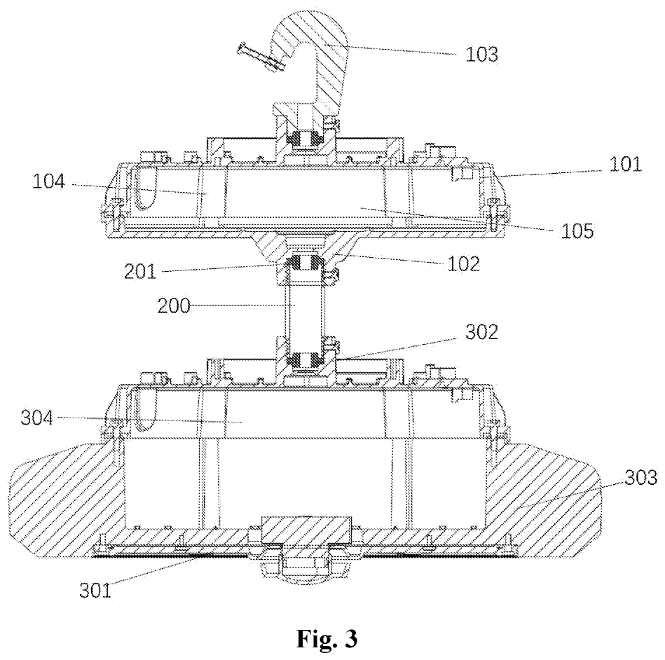

Please refer to FIG. 2 and FIG. 3. FIG. 2 is the exploded view of the emergency lighting device and FIG. 3 is the section view of the emergency lighting device of the invention. The emergency lighting device 10 comprises an emergency module 100, a connector 200 and a lighting module 300. The connector 200 has a cavity, one end thereof is connected with the emergency module 100 and the other end is connected with the lighting module 300. The cavity of the connector 200 forms a closed space after being connected with the lighting module 300 and the emergency module 100, the closed space separates the emergency module 100 from the lighting module 300 spatially to cut off the path of heat generated by the lighting module 300 to be transferred to the emergency module 100.

Particularly, the emergency module 100 comprises a housing 101, an emergency control 104 and a battery pack 105; the housing 101 comprises an upper housing and a lower housing (not indicated in the figure), and the upper housing and the lower housing can be fixedly connected to form a cavity by screws. Specifically, a sealing washer also can be arranged between the upper housing and the lower housing, and is fixedly connected with screws to form a closed cavity, and the emergency control 104 and the battery pack 105 are arranged in the cavity. As a preferred embodiment, the emergency control 104 and the battery pack 105 are evenly counterweighted, and the gravity centerline of the lighting device passes through the connector. The surface on one side of the housing 101, such as the surface of the upper housing, is provided with a fixed structure 103; the other surface opposite to the housing 101, such as the surface of the lower housing is provided with a first interface 102. The fixed structure 103 is integrated with the housing or is detachably arranged (screwed as shown in the figure) on the surface of the housing. The first interface 102 is connected with a connector 200 which may be a threaded pipe with holes on both ends, and wires can pass through the holes only. The outer surfaces of the pipe walls at both ends have threaded structures, and the inner surfaces of the first interface 102 have corresponding threaded structures. In another embodiment, the threaded structure of the connector 200 is arranged on the inner surface of the pipe, the end surface with a through hole is provided inside the connector 200, and the threaded structure of the first interface 102 is arranged on the outer surface. In another embodiment, the connector 200 and the first interface 102 can be firmly bolted. Other embodiments of common fixed connection methods are not listed here, as long as the cavity of the connector can form a closed space after installation. Preferably, the surface of the housing 101 is also provided with cooling fins to enhance the heat dissipation effect of the emergency module 100 and further reduce the ambient temperature of the emergency module.

The lighting module 300 comprises a light-emitting element 301, a light source driver 304, and a cooling element 303. The cooling element 303 comprises an upper part and a lower part (not indicated in the figure), the upper part and the lower part of the cooling element 303 are respectively provided with cavities, the light source driver 304 is arranged in the upper cavity, the light-emitting element 301 is arranged in the lower cavity, and multiple cooling fins are arranged on the outer surface of the cooling element 303. In addition, the upper outer surface of the cooling element 303 is also provided with a second interface 302, which is connected with the connector 200. Similar to the emergency module 100, the inner surface of the second interface 302 has a threaded structure, and the outer surface of the connector 200 has a corresponding threaded structure. In another embodiment, the threaded structure of the connector 200 is arranged on the inner surface of the pipe, while the threaded structure of the second interface 302 is arranged on the outer surface. In another embodiment, the connector 200 and the second interface 302 can be firmly bolted. Other embodiments of common fixed connection methods will not be listed here.

For the emergency lighting device 10 of the invention, the connector 200 is used to separate the emergency module 100 from the lighting module 300. The connector 200 is a threaded pipe, which separates the emergency module 100 from the lighting module 300 by a distance based on the size of the selected lighting module. The data in Table 1 is measured according to several embodiments of the invention. The ambient temperature under the experimental condition is higher than that in actual use. The ambient temperature of general products in actual use is below 45° C. The experimental temperature of 55° C. can ensure that the effect of products in actual use is better than the experimental effect:

TABLE 1

| | | | OD of | | | Temperature of | Temperature of | Temperature of |
|---|---|---|---|---|---|---|---|---|
| | Length of | | lighting | Length/ | Ambient | lighting module | connector | emergency module |
| | connector | | module | OD | temperature | cavity | cavity | cavity |
| Comparative | 0 | MM | 400 MM | — | 55° C. | 85.1° C. | — | 81.2° C. |
| example 1 | | | | | | | | |
| Example 1 | 50 | MM | 400 MM | 1:8 | 55° C. | 83.6° C. | 73.3° C. | 66.8° C. |
| Example 2 | 70 | MM | 400 MM | 1:5.8 | 55° C. | 82.8° C. | 71.2° C. | 63.3° C. |
| Example 3 | 100 | MM | 400 MM | 1:4 | 55° C. | 82.2° C. | 68.7° C. | 59.6° C. |

The data of comparative example 1 refers to the emergency lighting device in the prior art. The lighting module in fact comprises a light-emitting element and a light source driver. The emergency module is an emergency control, and the emergency control and the light source driver are arranged in the same cavity.

The experimental data shows that the stack effect is caused by the heat flow due to the convection heat dissipation of the thermal honeycomb of the lighting module. If the connector is not used, the cavity temperature of the emergency module can reach 78.4° C., which is much higher than the temperature that the emergency control can endure. In the experimental process, the emergency lighting device cannot work normally in case of flickering. Since the connector is adopted in the embodiment, the light module and the emergency module are separated by this connector, and the temperature of the emergency module is well controlled below the tolerable temperature. However, since the connector varies in length, the effect of heat flow temperature of the lighting module on the emergency module is different. The farther the distance and the larger the ratio of the corresponding length to the outer diameter, the less the effect of lighting module temperature on that of the emergency module cavity.

According to another embodiment of the invention, the emergency lighting device 10 further comprises a sealing plug 201. Specifically, the sealing plug 201 may be arranged between the connector 200 and the emergency module 100, and/or between the connector 200 and the lighting module 300. As a preferred embodiment, the sealing plug comprises a first sealing plug and a second sealing plug. The first sealing plug 201 is arranged in the first interface 102 and the second sealing plug 202 is arranged in the second interface 302. The sealing plugs 201, 202 are of thermally insulated conductor such as silica gel, wood, ceramics or glass, and the sealing plug 201 is provided with holes (not indicated in the figure) to facilitate electrical connection between the emergency module 100 and the lighting module 300 through wires, and the holes and the wires are in interference fit to achieve a sealing effect. The inventor has found that the sealing plug arranged has a better thermal insulation effect. Refer to the experimental data indicated in Table 2:

TABLE 2

| | | OD of | | | Temperature of | Temperature of | Temperature of |
|---|---|---|---|---|---|---|---|
| | Length of | lighting | Ambient | Sealing | lighting module | connector | emergency module |
| | connector | module | temperature | material | cavity | cavity | cavity |
| Comparative | 70 MM | 400 MM | 55° C. | Hollow pipe | 80.2° C. | 77.8° C. | 75.6° C. |
| example 2 | | | | | | | |
| Example 4 | 70 MM | 400 MM | 55° C. | Silica gel plug | 82.5° C. | 70.5° C. | 60.3° C. |
| Example 5 | 70 MM | 400 MM | 55° C. | Single-component | 82.3° C. | 70.8° C. | 60.5° C. |
| | | | | sealant | | | |
| Example 6 | 70 MM | 400 MM | 55° C. | Seal pipe | 82.8° C. | 71.2° C. | 63.3° C. |

The connector is used in comparative example 2, but it is an ordinary pipe with open ends, which could not form a closed space after being assembled, so the thermal convection effect could not be avoided.

The analysis of experimental data shows that the temperature of the lighting module cavity and that of the emergency module cavity can be effectively isolated after different sealing materials are used under effective sealing conditions. Under non-sealing condition, the air heat conduction effect is obvious due to interconnection of the internal cavities, and the temperature of the emergency cavity is greatly increased.

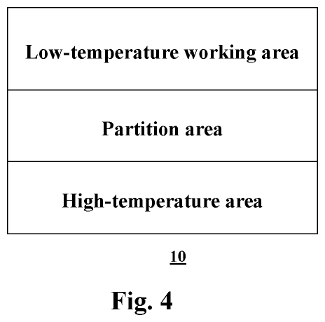

Refer to FIG. 4. This figure is the logic diagram showing the temperature reduction of the emergency module for the high bay light. The emergency lighting device can be divided into three parts, including a high-temperature area, a low-temperature area and a partition area according to the operating characteristics of all elements of the emergency lighting device 10, as shown in the figure. According to the thermodynamic analysis of the emergency lighting device, the effect of heat convection is much greater than that of heat conduction and heat radiation in three modes of heat transfer. As shown in FIG. 4, the partition area is arranged between the high-temperature area and the low-temperature working area, and set to be a closed space. The heat from the high-temperature area cannot reach the low-temperature area by convection, even the heat is transferred to the partition area. Convection occurs due to temperature difference in the enclosed space of the partition area. However, the heat is transferred to the partition area only by heat conduction and heat radiation in limited manner, and convection only occurs inside the partition area and has a very weak effect. In addition, the heat transferring from the partition area to the low-temperature working area can occur only by heat conduction and heat radiation. Therefore, the heat can be transferred from the high-temperature area to the low-temperature working area by heat conduction and heat radiation indirectly after passing through the partition area only. Because of the fast attenuation of such two heat transfer modes, the effect of the high-temperature working area on the low-temperature working area is reduced. Seen from the examples in FIG. 2-FIG. 3, the light-emitting element 301 in the lighting module 300 emits light to generate heat, and the circuit of the light source driver 304 generates heat, both of which are radiated through the cooling element 303, so that the lighting module 300 is the high-temperature area in the emergency lighting device. The emergency control 104 and the battery pack 105 in the emergency module have limited tolerable temperature and need to work at low temperature at the same time (relative to the lighting module). Therefore, the emergency module corresponds to the low-temperature working area in the emergency lighting device, and the cavity of the connector forms a closed space after being connected with the lighting module and the emergency module, corresponding to the partition area.

The invention further provides a method for reducing temperature thereof, comprising the following steps of:

I. Dividing the emergency lighting device into a high-temperature area, a low-temperature working area and a partition area;

II. Connecting the low-temperature working area and the high-temperature area with the partition area respectively to allow the partition area to form a closed space;

III. Separating the low-temperature working area from the high-temperature area by the closed space to cut off the heat convection between the high-temperature area and the low-temperature working area.

To sum up, a connector is creatively introduced to the emergency lighting device of the invention to separate the emergency module from the lighting module, so a closed space is formed between the lighting module and the emergency module to avoid the effect of heat convection generated in the operating process of the light-emitting element and the light source driver on the emergency module. Additionally, a sealing plug is also arranged between the connector and the emergency module and/or the lighting module to further partition the effect of the heat generated by the lighting module on the emergency module, resulting in excellent heat insulation effect. At the same time, the emergency module and the lighting module of the emergency lighting device are separated, so that the emergency lighting device and the general lighting device can be switched, for example, the emergency module 100 and the connector 200 are removed, and the fixed structure 103 of the upper housing of the housing 101 is connected to the second interface 302 of the lighting module 300 to realize rapid transformation. Similarly, using the opposite process, the common lighting device can be quickly transformed into an emergency lighting device.

The embodiments are only preferred embodiments of the invention, but not limit thereto. For a person skilled in the art, various variations and changes can be made to the invention. Any modification, equivalent replacement and improvement made within the range of the spirit and rule of the invention can be incorporated in the protection scope of the invention.

1. A high bay lighting device, comprising:
a lighting module having a light-emitting element, a light source driver and a cooling element, wherein the cooling element has a first interface to which a connector is connected;
an emergency module having a housing, an emergency control and a battery pack arranged in the housing, wherein one side of the housing is provided with a fixed structure, another opposite side is provided with a second interface, and the connector is connected to the second interface; and
the connector having a first end, a second end, and a cavity, and the first end being connected with the lighting module and the second end being connected with the emergency module; the cavity of the connector forming a closed space after being connected with the lighting module and the emergency module; and the closed space separating the emergency module from the lighting module to cut off the heat convection between them.

2. The high bay lighting device according to claim 1, wherein the emergency lighting device further comprises a sealing plug which is arranged between the connector and at least one of the lighting module and the emergency module.

3. The high bay lighting device according to claim 1, wherein the lighting module comprises the light-emitting element, the light source driver and the cooling element having first end part with a first cavity and a second end part, opposite to the first end part, and with a second cavity; the light source driver arranged in the first cavity and the light-emitting element arranged in the second cavity.

4. (canceled)

5. The high bay lighting device according to claim 1, wherein the emergency lighting device further comprises a first sealing plug which is arranged between the connector and the first interface.

6. (canceled)

7. The high bay lighting device according to claim 1, wherein one side of the housing is provided with the fixed structure, wherein the fixed structure is integrated with the housing or is detachably arranged on the surface of the housing.

8. The high bay lighting device according to claim 1, wherein the emergency control and the battery pack are arranged such that the gravity centerline of the lighting device passes through the connector.

9. The high bay lighting device according to claim 1, wherein the emergency lighting device further comprises a second sealing plug arranged between the connector and the second interface.

10. A method for reducing temperature of a high bay lighting device, comprising steps of:
i, dividing the high bay lighting device into a high-temperature area, a low-temperature working area and a partition area;
ii, connecting the low-temperature working area and the high-temperature area with the partition area respectively to allow the partition area to form a closed space;
iii, separating the low-temperature working area from the high-temperature area by the closed space to cut off the heat convection between the high-temperature area and the low-temperature working area.

11. A method for reducing temperature of a high bay lighting device, comprising:
dividing the high bay lighting device into an emergency module, a lighting module and a connector;
connecting the emergency module and the lighting module with the connector respectively to allow the connector to form a closed space;
separating the emergency module from the lighting module by the closed space to cut off the heat convection between the lighting module and the emergency module, wherein a ratio of connector length of closed space and a temperature reduction value of the emergency module of the high bay lighting device is within a range of 2-5.

12. The method of claim 11, wherein a sealing plug is arranged between the connector and at least one of the lighting module and the emergency module to further partition the effect of the heat generated by the lighting module on the emergency module.

13. The method of claim 11, wherein a first sealing plug is arranged between the connector and the lighting module to further partition the effect of the heat generated by the lighting module on the emergency module.

14. The method of claim 11, wherein a second sealing plug is arranged between the connector and the emergency module to further partition the effect of the heat generated by the lighting module on the emergency module.
